(19) United States
(12) Patent Application Publication
(10) Pub. No.: US 2013/0200196 A1
(43) Pub. Date: Aug. 8, 2013

(54) CABLE WINDER FOR FALL-ARREST LIFELINE COMPRISING A BRAKE AND CABLE RESERVE

(71) Applicant: Patrick Copin, Rilly-Sainte-Syre (FR)

(72) Inventor: Patrick Copin, Rilly-Sainte-Syre (FR)

(73) Assignee: TRACTEL SAS, Saint Hilaire Sous Romilly (FR)

(21) Appl. No.: 13/876,587

(22) PCT Filed: Sep. 29, 2011
(86) PCT No.: PCT/FR2011/052277

§ 371 Date: Mar. 28, 2013

(30) Foreign Application Priority Data
Sep. 29, 2010 (FR) 1057858

(51) Int. Cl. A62B 35/00; A62B 35/04

(52) U.S. Cl. CPC A62B 35/0093; A62B 35/04
USPC 242/383.2

(57) ABSTRACT

A cable (6a, 6b) winder (1) of a fall-arrest lifeline including a brake, the winder, which is intended to be attached to a holding point, includes a centrifugal brake in a housing, wherein the centrifugal brake is intended to slow the unwinding of the cable in the event of a fall, the cable winding onto a drum (2) from a first end attached to the shaft of the drum, the second end of the cable coming out of the winder and including an element for coupling to a load. The wound cable is furthermore secured to the drum at a predetermined distance from the first end by a removable securing element (5), the securing element ceasing to hold the cable on the drum when a tensile force greater than a release threshold is applied to the cable in order to release the predetermined cable distance.

The present invention relates to a winder with brake and cable reserve for fall protection lifeline cable. It has applications in the field of safety of persons.

Fall protection devices are known, which are in the form of cable winders. The cable is linked to a user and the winder is attached to a retaining point. The winder comprises a centrifugal brake that, upon detection of an angular acceleration of the drum on which the cable is wound, which is higher than a fixed limit, holds and slows down the cable and makes it possible to arrest more or less progressively the fall of the user. On the other hand, during normal displacements and movements of the user, the cable can, according to the case, unwind from the winder or wind in the latter.

Therefore, in the event of a fall, the user is stopped in his/her fall in a more or less progressive way, and, in any case, not in a brutal way. There results less stresses on the user and the equipments, the energy of fall arrest being dissipated within the brake. There also results a less risk of user injury and equipment breakage. If this type of fall protection device offers useful services, a difficulty persists in the case where the cable has been fully or almost fully unwound before the fall occurs. In this case, the cable can no longer unwind, or not sufficiently, and the brake cannot operate correctly: there is no longer possibility of progressive slowing down and the fall arrest is then brutal, with consequently the mentioned risks for the user and the equipment.

The present invention proposes a means that makes it possible to slow down a fall even when the cable has been fully unwound in the normal conditions of use.

The document EP 272 908 discloses a winder with cable reserve, but the latter implements means that are independent of the drum on which the cable is wound. There results for example that, in the event of a fall, it may be necessary to change, in addition to the cable and the drum to which it is attached by its cable end, other parts of the winder.

The documents WO2008/008225 and US 2005/023085 also disclose winders. However, in these winders, the arrangement of the means making it possible to obtain a cable reserve interferes with the natural winding of the cable.

The present invention proposes an alternative solution in which only the drum may be concerned by the effects of the fall releasing the cable reserve. Preferably, after a fall, a thorough examination of the equipment must be made and the deteriorated components must be changed.

For that purpose, a removable means for fastening the cable to its winding drum is implemented at a determined distance from the terminal end of the cable attached to the drum shaft. This fastening means gives way or is released in the event of a high traction force exerted on the cable, liable to correspond to a fall, but not for the usual and normal traction forces exerted on the cable. Therefore, a cable reserve is released in the event of a fall and the cable may continue to unwind so that the brake can operate.

More precisely, the invention relates to a winder with a brake for fall protection lifeline cable, said winder, intended to be attached to an anchoring point, comprising in a housing a centrifugal brake for slowing down the cable unwinding in the event of a fall, wherein the cable winds on a drum from a first end attached to the shaft of said drum, with the second end of the cable coming out of the winder and comprising a means for coupling to a load.

According to the invention, the wound cable is further fastened to the drum at a determined distance from said first end by a removable fastening means, said fastening means stopping to hold the cable on the drum when a traction force higher than a predefined triggering threshold is applied to the cable, so as to release said determined cable distance.

In various embodiments of the invention, the following means are employed, which can be used either alone or in any technically possible combination thereof:
the load is an operator equipped with a harness and with his/her possible tools,
the centrifugal brake is a disk brake,
the disk brake enters into function when the angular acceleration detected by the centrifugal device is higher than an activation threshold,
the triggering threshold corresponds to a traction force on the cable that is higher than the tractions forces usually exerted on the cable but lower than a traction force due to a fall of the load,
the removable fastening means is reversible, wherein the cable can be refasten to the drum after the fastening means has stopped to hold the cable on the drum following a traction force applied to the cable, which is higher than the triggering threshold,
in the case where the cable can be refastened to the drum, the refastening requires human intervention,
in the case where the cable can be refastened to the drum, the refastening is automatic,
the removable fastening means is irreversible, wherein the fastening means definitely gives way or steps aside following a traction force applied on the cable, which is higher than the triggering threshold,
the fastening means is a fall indicator,
the winder comprises such means that, in the case of an irreversible removable fastening means, the drum and its fastening means are no longer reusable following a traction force applied on the cable, which is higher than the triggering threshold, for example due to the fact the drum has been deformed or is partially broken,
the winder comprises such means that, in the case of an irreversible removable fastening means, the drum is reusable following a traction force applied on the cable, which is higher than the triggering threshold, a replacement fastening means being installed on said drum, as only the fastening means has given way or stepped aside,
the determined distance of the cable between its first end attached to the drum shaft and the removable fastening means is such that it remains on the drum between one turn and three turns of releasable cable,
the determined distance of the cable between its first end attached to the drum shaft and the removable fastening means is such that it remains about one turn of cable on the drum,
the determined distance of the cable between its first end attached to the drum shaft and the removable fastening means is such that it remains at least one turn of cable on the drum,
the determined distance of the cable between its first end attached to the drum shaft and the removable fastening means is such that it remains at least three turns of cable on the drum,
in the case where it remains more than one turn available on the drum, the winder is configured so that the releasable part of cable does not interfere with the operation of the removable fastening means, in particular does not stick nor goes back on said removable fastening means,
the fastening stopping is progressive, for example through bending of a pin removably fastening the cable to the drum,
the fastening stopping is brutal, for example through breaking of a pin removably fastening the cable to the drum and/or breaking of the zone of attach of the fastening means to the drum,
the winder further comprises a means for automatic return and winding of the cable, in the form of a return spring acting on the drum,
the winder further comprises a means for manual winding of the cable, in the form of a crank,
the retaining point is fixed, for example an eye bolt, a hook,
the retaining point is mobile, for example a lifeline slider or a mobile arm of supporting pylon,
the winder comprises several removable fastening means adapted to give way or step aside the ones after the others during a same fall,
the winder comprises several removable fastening means giving way or stepping aside the ones after the others, fall after fall,
the drum is made of plastic material and the fastening means is a metal rod attached in the drum,
the fastening means is a metal rod attached in the drum,
the metal rod is substantially parallel to the rotation shaft of the drum,
the metal rod is arranged substantially level with the hub of the drum,
the fastening means is a cable fastener attached to the drum hub,
the fastening means is a cable fastener attached to one of the two side flanges of the drum,
the cable fastener is an omega-shaped lug saddling over the cable,
the cable fastener is a nylon cable fastener,
the drum is made of plastic material,
the brake is metallic,
the centrifugal brake comprises a clutching means for said brake, operating by centrifugal force,
the winder comprises in the drum hub an opening for access to the rotation shaft of the drum, for the passage of the cable end for terminal loop attachment of said cable to said rotation shaft and the metal rod is arranged in said opening.

The present invention, without being limited thereby, will now be exemplified by the following description of embodiments and implementations, in relation with:

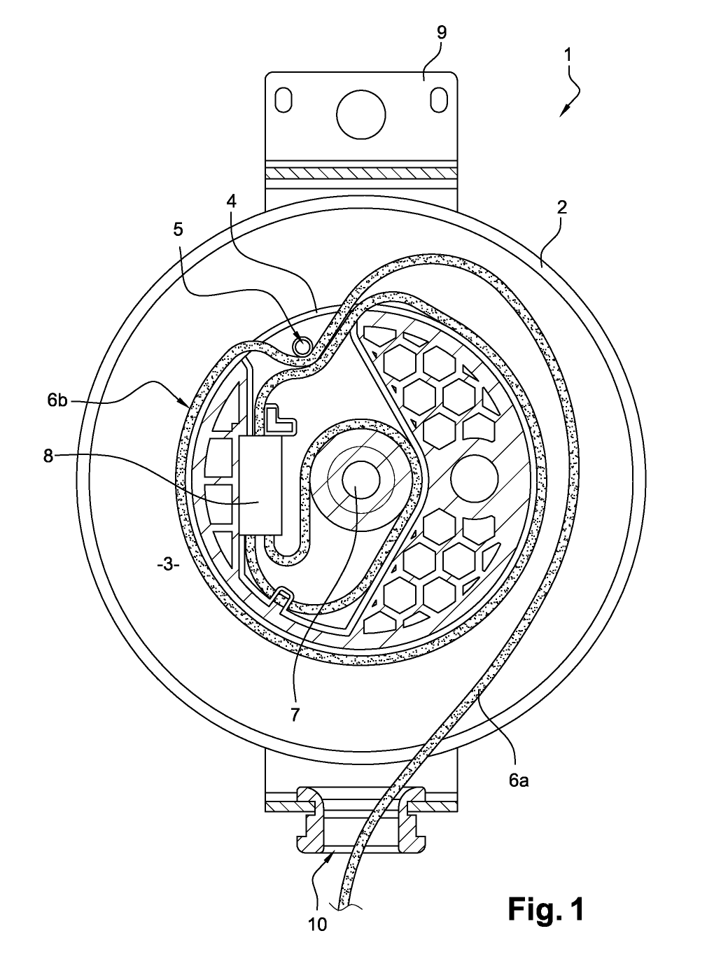

FIG. 1, which shows a sectional view of a portion of a winder according to the invention, and

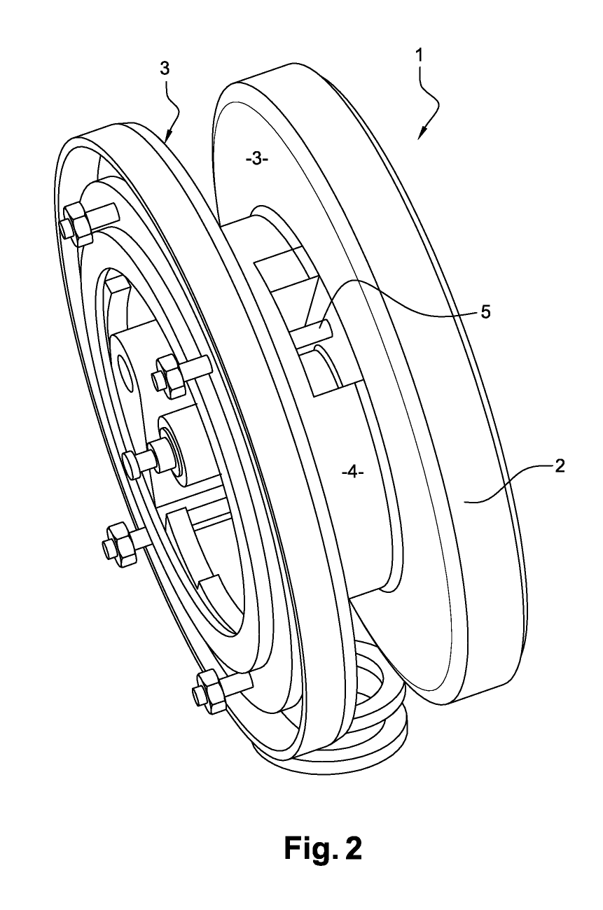

FIG. 2, which shows a perspective view of a portion of a winder according to the invention.

In the simplified figures that will now be described, all the components of the winder have not been shown, such as for example the brake, the cable return device for the winding thereof after it has been unwound, possible components for operation locking and/or unlocking.

In FIG. 1, the winder 1 is partially disassembled and it has been kept the drum 2 and a part of the other elements of the winder, of which, upward, a part 9 for attachment to a fixed point and, downward, a part 10 for guiding the cable at the cable input/output of the winder. Still in FIG. 1, the drum 2 is shown in sectional view and only one of the two flanges 3 of said drum is seen. The cable is wound on the drum between the flanges, on the hub 4 of said drum. On this explanatory Figure, the cable has been almost fully unwound and it remains about half a turn of cable length that can be unwound before the normal stopping of the cable unwinding. The stopping is qualified as normal because it corresponds to an unwinding due to a normal traction of the cable but not to a traction due to a fall, in which case the traction force would be far higher. Indeed, the cable is fastened by a removable fastening means 5 to the drum, at a determined distance from its terminal end attached to the rotation shaft of the drum. This fastening means resists to the normal traction forces, which causes the normal stopping of the cable unwinding when this removable fastening means comes substantially down, in relation with the cable guiding part 10. The part of cable that can be unwound before the normal stopping is qualified as useful cable 6a and, in the example shown, it remains at the hub 4 about half a turn of useful cable length 6A that can be unwound. On the other hand, if the traction effort exerted on the cable is higher than the holding strength of the removable fastening means 5, the latter steps aside and/or gives way, which releases the remaining of the cable toward its terminal end attached to the rotation shaft of the drum, in such a way that this attachment resists to the forces due to falls.

The part of cable between the removable fastening means 5 and its terminal end attached to the drum is qualified as round-turn cable 6b. In the example shown, the length of the round-turn cable 6b substantially corresponds to one turn of the drum hub. The terminal attachment of the cable end, in this case the round-turn cable 6b part, is obtained by making a closed loop 8 that surrounds the rotation shaft of the drum. It is understood that another type of attachment to the drum is possible for the cable end providing that this terminal attachment resists to the traction forces met during falls. The holding strength of the cable on the drum can be defined by a triggering threshold corresponding to the minimal traction force that must be applied to the cable, with the winder held at a fixed point, so that the removable fastening means 5 stops holding the cable on the drum.

The removable fastening means 5 is herein a preferably metallic rod that is inserted in the drum, preferably made of plastic material. The rod extends substantially parallel to the rotation shaft of the drum and is placed substantially level with or a little below the drum hub, within an opening of the hub formed toward the center of the drum, which opening herein corresponds to a cable trough allowing the making of the terminal loop 8 for attachment of the cable to the rotation shaft of the drum.

It is understood that the fastening means 5, when a traction force higher than the triggering threshold is applied thereto, will be pulled substantially radially toward the outside of the drum by the cable, which will cause its bending and/or breaking and/or tearing out from the drum, and thus the releasing of the round-turn part of the cable. This releasing will permit the unwinding of this round-turn part of the cable and the brake action. It is also understood that this embodiment is non-reversible, single-use, because the removable fastening means and/or the drum undergo(es) irreversible deformations and/or breakages. It is then necessary to change the drum and the removable fastening means so that the winder can be reused with all its capacities.

The fastening means, in particular when it is irreversible or reversible but then requiring human action for being restored, may be used as a fall indicator, its breakage (or that of a drum portion) or its stepping aside signaling that a fall has occurred with releasing of the round turn(s).

The length of round-turn cable may correspond to more than one turn of drum but, in this case, it is made sure that the round-turn cable that goes back (radially toward the outside of the drum) on the removable fastening means does not interfere with the latter, which could modify the triggering threshold. Among the possible solutions, the round turn is caused to go back laterally to the removable fastening means (on the hub side with no opening) or the fastening means is placed toward the inside of the hub, within the opening of the hub, so that the cable saddles back above and remote from the fastening means. As an alternative, the round-turn cable is caused to go back (radially toward the inside of the drum) under the removable fastening means.

FIG. 2 makes it possible to better visualize on the drum 2, the hub 4 and the removable fastening means 5 arranged in the hub opening. Preferably, the hub opening has a reduced width, not extending from one flange 3 to the other 3.

Of course, the present invention is not limited to the particular embodiments that have been described, but covers any variant and equivalent within the scope thereof. It is therefore well understood that the invention may be declined according to many other possibilities without thereby departing from the scope of the invention defined by the description and the claims.

1. A winder (1) with a brake for fall protection lifeline cable (6a, 6b), said winder, intended to be attached to an anchoring point, comprising in a housing a centrifugal brake for slowing down the cable unwinding in the event of a fall, wherein the cable winds on a hub of a drum (2) from a first end attached to the shaft of said drum, with the second end of the cable coming out of the winder and comprising a means for coupling to a load,
wherein the wound cable is further fastened to the drum at a determined distance from said first end by a removable fastening means, said fastening means stopping to hold the cable on the drum when a traction force higher than a predefined triggering threshold is applied to the cable, so as to release said determined cable distance, characterized in that the removable fastening means is a rod (5) extending substantially parallel to the rotation shaft of the drum and arranged in an opening of the hub of said drum.

2. The winder according to claim 1, characterized in that the centrifugal brake is a disk brake.

3. The winder according to claim 1, characterized in that the drum is made of plastic material and the fastening means is a metal rod (5) attached in the drum.

4. The winder according to claim 1, characterized in that the removable fastening means is irreversible, wherein the fastening means definitely gives way or steps aside following a traction force applied on the cable, which is higher than the triggering threshold.

5. The winder according to claim 4, characterized in that it comprises such means that, in the case of an irreversible removable fastening means, the drum and its fastening means are no longer reusable following a traction force applied on the cable, which is higher than the triggering threshold.

6. The winder according to claim 4, characterized in that it comprises such means that, in the case of an irreversible removable fastening means, the drum is reusable following a traction force applied on the cable, which is higher than the triggering threshold, a replacement fastening means being installed on said drum, as only the fastening means has given way or stepped aside.

7. The winder according to claim 1, characterized in that the determined distance of the cable between its first end attached to the drum shaft and the removable fastening means is such that it remains on the drum between one turn and three turns of releasable cable.

8. The winder according to claim 1, characterized in that it further comprises a means for automatic return and winding of the cable, in the form of a return spring acting on the drum.

9. The winder according to claim 1, characterized in that it the opening of the drum hub offers access to the rotation shaft (7) of the drum for the passage of the cable end for terminal loop attachment (8) of said cable on said rotation shaft and the metal rod (5) is arranged in said opening.

10. The winder according to claim 2, characterized in that the drum is made of plastic material and the fastening means is a metal rod (5) attached in the drum.

11. The winder according to claim 2, characterized in that the removable fastening means is irreversible, wherein the fastening means definitely gives way or steps aside following a traction force applied on the cable, which is higher than the triggering threshold.

12. The winder according to claim 3, characterized in that the removable fastening means is irreversible, wherein the fastening means definitely gives way or steps aside following a traction force applied on the cable, which is higher than the triggering threshold.

13. The winder according to claim 2, characterized in that the determined distance of the cable between its first end attached to the drum shaft and the removable fastening means is such that it remains on the drum between one turn and three turns of releasable cable.

14. The winder according to claim 2, characterized in that it further comprises a means for automatic return and winding of the cable, in the form of a return spring acting on the drum.

15. The winder according to claim 2, characterized in that it the opening of the drum hub offers access to the rotation shaft (7) of the drum for the passage of the cable end for terminal loop attachment (8) of said cable on said rotation shaft and the metal rod (5) is arranged in said opening.
